(19) United States
(12) Patent Application Publication
(10) Pub. No.: US 2015/0300310 A1
(43) Pub. Date: Oct. 22, 2015

(54) FRICTION STARTER DRIVE UNIT FOR MESHING WITH A STARTER RING GEAR OF A HEAT ENGINE, AND CORRESPONDING HEAT ENGINE STARTER

(71) Applicant: VALEO EQUIPEMENTS ELECTRIQUES MOTEUR, Creteil Cedex (FR)

(72) Inventor: Guillaume SEILLIER, La Verpilliere (FR)

(21) Appl. No.: 14/435,063

(22) PCT Filed: Oct. 31, 2013
(86) PCT No.: PCT/FR2013/052605

§ 371 Date: Apr. 10, 2015

(30) Foreign Application Priority Data
Oct. 31, 2012 (FR) 1260388

(51) Int. Cl. F02N 15/02; F02N 15/06; F16D 13/69

(52) U.S. Cl. CPC F02N 15/025; F16D 13/69; F02N 15/067

(57) ABSTRACT

A friction starter drive unit comprises a drive pinion for meshing with a starter ring gear. A drive element and a friction clutch are between the drive element and the drive pinion. The friction clutch has a reaction element rotatably fixed to the drive pinion and a pressure element solidly connected to the drive element. The drive element moves relative to the reaction element between uncoupled and coupled positions, and a resilient means biases the reaction element and the drive element toward the uncoupled position. A retaining washer is rotatably fixed to the reaction plate or the drive element. When the retaining washer is rotatably linked to the reaction plate, the resilient means is positioned between the reaction plate and the retaining washer, and, when the retaining washer is rotatably linked to the drive element, the resilient means is positioned between the drive element and the retaining washer.

### DOMAIN OF THE INVENTION

The invention relates to a friction starter drive unit for meshing with a starter ring gear of a heat engine, in particular of a motor vehicle. The invention is also directed towards the starter drive unit of a heat engine comprising such a unit.

The invention is particularly advantageous when applied to vehicles equipped with the function of stopping and re-starting the engine (known as “stop and start” function in English) according to the traffic conditions fitted with booster starters.

### PRIOR ART

In order to start up the heat engine of a vehicle, it is known to use a starter capable of transmitting mechanical energy to turn a crankshaft of the motor by the intermediary of toothed wheels. To this effect, the starter comprises a pinion mounted on a drive shaft driven in rotation by a rotor of an electric motor. This pinion is equipped with teeth able to engage with teeth of a toothed wheel coupled to the crankshaft of the engine known as starter ring gear.

In a booster starter the drive pinion is part of a starter assembly fitted so that it can move in translation on a drive shaft to pass from a rest position in which the drive pinion is disengaged from the starter ring gear to an active position in which the drive pinion is engaged with the starter ring gear and conversely.

To this effect a booster starter assembly 1 shown on FIG. 1 comprises drive pinion 2, a driver 3 mounted on an output shaft of an electric motor via a helical connection, and a friction clutch 5 interposed between pinion 2 and driver 3.

Friction clutch 5 comprises a pressure element 6 consisting of a shoulder of driver 3, a reaction plate 8 consisting of a plate solidly connected to the drive pinion 2, as well as friction discs 9 situated between pressure element 6 and reaction plate 8. Driver 3 can move in translation in relation to reaction plate 8 between an uncoupled position in which driver 3 and pinion 2 are decoupled in rotation and a coupled position in which pinion 2 and driver 3 are coupled in rotation to one another.

Discs 9 are accommodated in a housing 11 delimited by reaction plate 8 connected to pinion 2, an annular skirt 12 of axial orientation linked to the external periphery of reaction plate 8, also by a locking ring 14 crossed centrally by driver 3. In addition, ring 14 is hollowed out to its external periphery in an annular way to mount an assembly cap 15 of the ring and of skirt 12 onto reaction plate 8.

A spring washer 18 of axial action is mounted in an annular channel 19 formed by a reduction in thickness which plate 8 presents on its internal periphery. This washer 18 is supported on reaction plate 8 and an end of driver 3 to act on driver 3 and to push this back, that is to say in a direction opposed to reaction plate 8.

Driver 3 also has a channel 21 delimited by two transverse walls 22, 23 inside which the lower part of a control lever of the starter is intended to be assembled. A wall 22 known as pusher corresponds to the wall against which the lever rests in order to push driver 3 in the direction of the starter ring gear. The other wall 23 known as puller is a wall against which the lever rests to move driver 3 away from the starter ring gear.

The operation of the prior art starter unit is described below.

In rest position, driver 3 being in the uncoupled position, the discs 9 are not tight up against each other so that friction clutch 5 is disengaged when an axial play J spread between reaction plate 8, discs 9 and pressure plate 6 appears.

Starting from the rest position towards the final position, the control lever acts on ring 14 of housing 11 which then axially moves pinion 2 in the direction of the starter ring gear along the output shaft of the motor. During this stage, driver 3 is in the uncoupled position so that pinion 2 is free to rotate in both directions of rotation. The axial movement continuing, pinion 2 arrives in the vicinity of the starter ring gear.

In a second stage pinion 2, free to rotate, slightly penetrates the ring. The lever in contact with pusher 22 axially moves driver 3 and shoulder 6 of the latter in the direction of reaction plate 8. Spring washer 18 is then compressed and the play J is cancelled. Driver 3 then passes from the uncoupled position to the coupled position in order to transmit the torque of pinion 2 to the starter ring gear.

When the ring gear turns more quickly than the shaft supporting pinion 2, the friction clutch is released because driver 3 performs an axial movement towards the rear due to the helical connection between driver 3 and the shaft. Driver 3 screws off. This action is amplified by spring washer 18 which is de-tensioned and pushes driver 3 towards the rear.

However, in the event of over-speed of pinion 2 during the declutching phase, spring washer 18 has a tendency to rub against one of the rotating elements between which it is positioned, that is to say reaction plate 8 or the end of driver 3, which causes premature wear of spring washer 18.

### OBJECT OF THE INVENTION

The invention is directed towards prolonging the service life of the spring washer by avoiding its premature wear due to the rotating components surrounding it.

To this effect, the object of the invention is a friction starter drive unit for heat engines of motor vehicles comprising:

a drive pinion for meshing with a starter ring gear of a heat engine,

a drive element,

a friction clutch operating between the drive element and the drive pinion, said friction clutch comprising a reaction element rotatably fixed to the drive pinion, and a pressure element solidly connected to the drive element,

the drive element being able to move in translation in relation to the reaction element between an uncoupled position in which the drive element and the drive pinion are decoupled in rotation and a coupled position in which the drive pinion and the drive element are coupled to one another, and

a resilient means exerting a force on the reaction element and the drive element in the direction of the uncoupled position, in which it also comprises a washer, known as retaining washer, rotatably fixed to either the reaction plate or the drive element, and

in the case where the retaining washer is rotatably linked to the reaction plate, the resilient means is positioned between said reaction plate and the retaining washer, and

in the case where the retaining washer is rotatably linked to the drive element, the resilient means is positioned between said drive element and the retaining washer.

Thus, in the event of over-speed of the drive pinion during the declutching phase, the resilient means is protected by the retaining washer insofar as, in both cases illustrated, the retaining washer rotatably linked to the reaction element or the drive element, and not the resilient means, rubs against the other rotating element opposite which the retaining washer is positioned. The resilient means wedged between the retaining washer and the element, to which said retaining washer is rotatably linked, then does not have any relative rotating movement in relation to the components surrounding it and thus cannot be subject to premature wear.

Therefore the starter has a resilient means exerting a force between the pinion and the drive element so as to separate them from one another in order to decouple the drive element from the pinion. The resilient means thus exerts a force between the drive element and the pinion so as to release the clutch.

In the case where the retaining washer is rotatably linked to the reaction plate, the resilient means is positioned between said reaction element and the retaining washer. The resilient means is thus in contact with said reaction plate and the retaining washer so as to push the retaining washer in the direction of the drive element. In coupled position, the drive element is in contact with the washer and exerts a force on the retaining washer, which in contact with the resilient means compresses the resilient means in contact with the reaction plate. In uncoupled position, the resilient means does not rotate with its two surfaces in contact and thus does not wear. The resilient means is therefore in contact with a surface of the retaining washer and a surface of the reaction plate.

In the case where the retaining washer is rotatably linked to the drive element, the resilient means is positioned between said drive element and the retaining washer. The resilient means is in contact with said drive element and the retaining washer so as to push the retaining washer in the direction of the reaction element. In coupled position, the reaction element is in contact with the washer and exerts a force on the retaining washer which in contact with the resilient means compresses the resilient means in contact with the drive element. In uncoupled position, the resilient means does not rotate in contact with either of these two surfaces and thus does not wear. The resilient means is therefore in contact with a surface of the retaining washer and a surface of the reaction plate.

According to a mode of embodiment, the friction clutch comprises at least one friction element situated between the pressure element and the reaction element.

According to a mode of embodiment, the retaining washer being rotatably linked to the reaction element, the resilient means is positioned between a radial surface of the reaction element and the retaining washer.

According to a mode of embodiment, the resilient means and the retaining washer are positioned inside a channel formed in the reaction element.

According to a mode of embodiment, the retaining washer on its external periphery comprises at least one lug intended to cooperate with at least one notch of corresponding shape situated on the external periphery of the channel.

According to a mode of embodiment, the retaining washer on its external periphery comprises three lugs spaced angularly apart from one another in a regular way intended to cooperate with three notches of corresponding shape situated on the external periphery of the channel.

According to a mode of embodiment, the lug(s) as well as the corresponding notches present a substantially rectangular shape.

According to a mode of embodiment, the channel is formed by a circular channel facing a radial surface of an end of the drive element.

According to a mode of embodiment, the channel is radially delimited by an internal annular wall and an external annular wall of axial orientation in relation to an axis of the friction starter drive unit.

According to a mode of embodiment, the internal annular wall consists of an extension of a sleeve supporting the drive pinion.

According to a mode of embodiment, the resilient means consists of a retaining washer.

According to a mode of embodiment, the retaining washer is protected with a coating obtained by carbonitriding.

According to a mode of embodiment, the reaction element is a plate rotatably fixed to the drive pinion.

According to a mode of embodiment, the reaction plate connected to the drive pinion, an annular skirt of axial orientation linked to the external periphery of the reaction plate and a locking ring crossed centrally by the drive element delimit a housing inside of which the friction element is positioned.

The object of the invention is also a starter for a motor vehicle heat engine equipped with a friction starter drive unit according to the invention.

### BRIEF DESCRIPTION OF THE FIGURES

The invention will be understood better on reading the description below and examining the figures accompanying it. These figures are provided on a purely illustrative basis and are by no means restrictive of the invention.

FIG. 1, already described, shows a perspective view of a friction starter drive unit according to the prior art;

FIGS. 2 and 3 respectively illustrate longitudinal sectional views of a heat engine starter unit according to the invention in rest position and active position;

FIG. 4 shows a perspective view of a friction starter drive unit according to the invention in longitudinal section;

FIG. 5 shows a perspective view of the body for the pinion and retaining washer of the friction starter drive unit on FIG. 4 rotatably linked to the body of the pinion;

FIG. 6 shows a perspective view of the body for the pinion and channel for accommodating the resilient means and retaining washer;

FIG. 7 shows a perspective view of the retaining washer used in the friction starter drive unit on FIG. 4;

FIGS. 8, 8a and 9 illustrate a lateral view of the spring washer used in the friction starter drive unit on FIG. 4;

FIG. 10 illustrates another mode of embodiment.

Identical, similar or analogous components in the figures keep the same reference symbol.

### DESCRIPTION OF EXEMPLARY EMBODIMENTS OF THE INVENTION

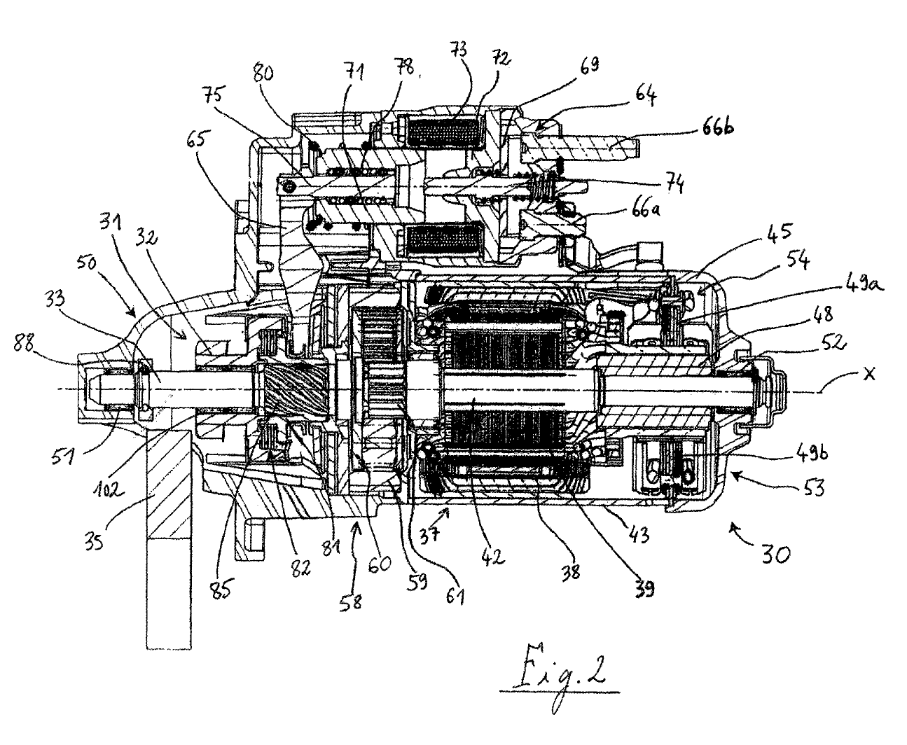

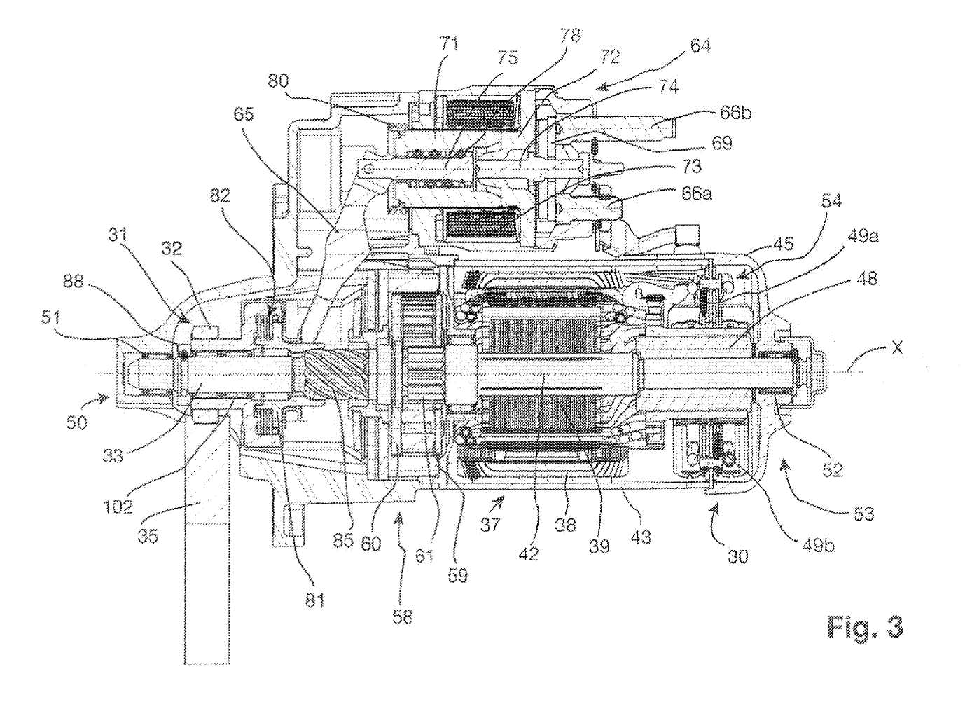

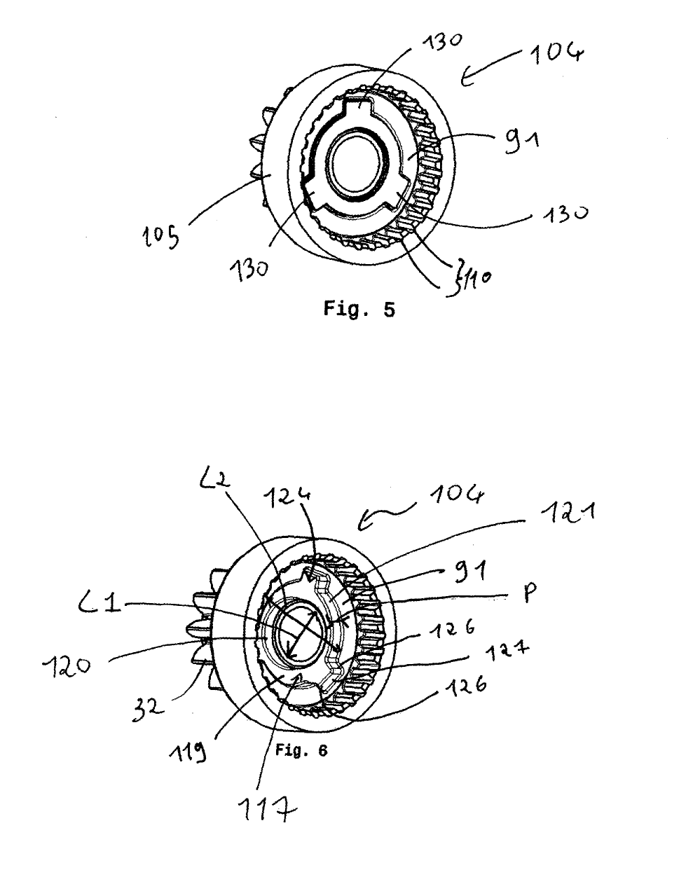

With reference to FIGS. 2 and 3, starter 30 comprises a friction starter drive unit 31 fitted with a drive pinion 32, described in more detail below, mounted so it can move in translation on a drive shaft 33. Starter drive unit 31 can pass from a rest position illustrated on FIG. 2 in which drive pinion 32 is disengaged from a starter ring gear 35 of a heat engine to an active position illustrated on FIG. 3 in which drive pinion 32 engages the starter ring gear 35, and vice versa.

To this effect, starter 30 comprises an electric motor 37 consisting of a stator 38 and a rotor 39 assembled in a coaxial manner. Stator 38 surrounds rotor 39, which is designed so as to rotate on a shaft 42 of X axis known as rotor shaft inside a cylinder head 43. The latter is solidly connected to a support 45 of the starter intended to be mounted on a fixed part of the motor vehicle. Stator 38 for example comprises an inductive coil comprising two pairs of windings, which are each wound around a polar mass solidly connected to the cylinder head. The axis of each winding is radial in relation to the X axis of the rotor. Alternatively or additionally, stator 38 comprises a plurality of permanent magnets.

Rotor 39 assembled on rotor shaft 42, comprises a packet of sheets provided with grooves for mounting electrical conductors in the shape of pins. These conductors are connected together to form a rotor coil in contact with conducting segments belonging to a collector 48 solidly connected to rotor shaft 42 cooperating with brushes 49a, 49b described below. The X axis of rotor shaft 42 is combined with the axis of drive shaft 33.

The front end of drive shaft 33 is mounted so it can move in translation in a bearing, known as front bearing 50, by the intermediary of a rolling bearing 51. The rear end of rotor shaft 42 is mounted in a rolling bearing 52 of a bearing 53 at the rear of the starter, known as rear bearing, and which is solidly connected to a brush carrier 54.

In the remainder of the description, front to rear orientation corresponds to left to right orientation on FIGS. 2, 3 and 4. In the present case, a front face of a part is the face directed towards front bearing 50 and the rear face is the face directed towards rear bearing 53.

Starter 30 also comprises a reduction gear system 58 fitted between rotor shaft 42 and drive shaft 33, the end of which is connected to rotor shaft 42 and the other end is connected to drive shaft 33. Reduction gear system 58 is in fact an epicycloidal gear train comprising an internally toothed cylindrical ring gear 59 which is rotatably immobilized. The teeth of ring gear 59 engage satellite pinions assembled so as to rotate around axles supported by a transversal plate 60 solidly connected to the rear end of drive shaft 33. Planetary gear 61 is connected to the front end of rotor shaft 42.

In an alternative, reduction gear system 58 can be any other type of speed-reduction gear. For example, reduction gear system 58 could comprise two toothed wheels, one of which is solidly connected to rotor shaft 42 and the other to drive shaft 33. In this example, the two axes of rotor shaft 42 and drive shaft 33 are offset in parallel relative to one another. According to another example, reduction gear system 58 can comprise crossed gears or convergent gears. In these two types of reduction gear system 58, the axis of drive shaft 33 and the axis of rotor shaft 42 are convergent respectively or neither parallel nor convergent.

Starter 30 also has a system for shifting starter drive unit 31 from its rest position to its active position and vice versa. This shifting system has an electromagnetic contactor 64 extending parallel to electric motor 37, being installed radially above the latter, and a control lever 65 in the shape of a fork.

The set of brushes 49a and 49b is provided for energising rotor coil 39. At least one of brushes 49b is electrically connected to the mass of the starter, for example support 45, and at least one other of brushes 49a is electrically connected to an electric terminal 66a of the contactor, for example via a wire. Brushes 49a and 49b rub on the commutator segments 48 when rotor 39 rotates. Starter 30 may comprise a plurality of brushes.

Contactor 64, beside terminal 66a linked to the brush, comprises a terminal 66b intended to be connected via an electric connection element to a positive electricity supply V+ of the vehicle, in particular a battery, not shown. A normally open contact (not shown), situated between a V+ terminal of the electricity supply and terminal 66b controls the supply of contactor 64 to start the electric motor.

Contactor 64 comprises a mobile contact plate 69 to electrically link the terminals 66a and 66b in order start electric motor 37. Contactor 64 is also able to activate control lever 65 to shift starter drive unit 31 along the X axis of drive shaft 33 from the rest position to the active position and vice versa. Contactor 64 also comprises a mobile core 71, a fixed core 72, a fixed coil 73, a control rod 74 and a mobile rod 75.

Control rod 74 passes through fixed core 73 which it uses as a guide. The front end of this control rod 74 rests against fixed core 72 and its rear end is fixed to contact plate 69. Control rod 74 is subject to the action of a contact spring (not referenced) compressed between a shoulder of control rod 74 and contact plate 69 in order to insure electrical contact of contact plate 69 with terminals 66a and 66b when mobile core 72 is in a so-called magnetic position. The front end of mobile rod 75 is fixed to control lever 65. When coil 73 is energised, mobile core 71 is attracted towards fixed core 72 until it is in the magnetic position. Its displacement simultaneously drives mobile rod 75, contact plate 69 and control rod 74 towards the rear. Mobile rod 71 is also subjected to a tooth to tooth spring 78 housed inside mobile core 71 and surrounding mobile rod 75. This tooth to tooth spring 78 is supported on a front shoulder of mobile rod 71 and a rear shoulder of mobile core 71. This tooth to tooth spring 78 is compressed when contact plate 69 moves towards terminals 66a and 66b and when control lever 65 can no longer advance pinion 32. Lever 65 cannot advance any further when pinion 32 is blocked in translation along the X axis in the direction of ring gear 35 by one or more teeth of ring gear 35. This blocked state is known as “tooth to tooth position”. The compression of tooth to tooth spring 78 enables shocks to be absorbed by exerting a force on control lever 65 transmitted to pinion 32 towards the active position. Contactor 64 also comprises a return spring 80, supported on fixed coil 73 and mobile core 71 to urge it forward until it reaches its rest position and simultaneously shifts control lever 65 until pinion 32 is in the rest position.

As evident on FIG. 4, friction starter drive unit 31 comprises drive pinion 32, a drive element 81 activated by control lever 65, and a friction clutch 82 axially installed between drive element 81 and pinion 32. Drive element 81 is provided internally with helical grooves 84 in a complementary manner engaging external helical teeth 85 supported by drive shaft 33 (see FIGS. 2 and 3). Starter drive unit 31 is thus activated by a helical movement when it is shifted by lever 65 against thrust bearing 88 (see FIG. 3) to engage ring gear 35 by the intermediary of pinion 32 in an active position.

Friction clutch 82 disposed between pinion 32 and drive element 81 comprises a reaction element 91 solidly connected to drive pinion 31, a pressure element 92 solidly connected to drive element 81, and a set of friction discs 93, 94 situated between reaction element 91 and pressure element 92. Pressure element 92 can axially move in relation to reaction element 91 within the limit of an axial play. Thus, drive element 81 can pass from an uncoupled position, in which drive element 81 and pinion 32 are decoupled in rotation, to a coupled position, in which drive element 81 and drive pinion 32 are coupled in rotation to one another, and vice versa. In uncoupled position, pinion 32 is decoupled in rotation in both directions of rotation of drive shaft 33, while in the coupled position, drive shaft 33 is solidly connected to pinion 32 in the starting direction of rotation.

In the present case, pressure element 92 is formed by a shoulder of radial orientation of drive element 81. Reaction element 91 is formed by a plate fixed to drive pinion 32. The term fixed signifies “solidly connected in rotation and in translation”.

More precisely, drive element 81 comprises a cylindrical bore 96 of X axis to be assembled around drive shaft 33. This X axis in addition corresponds to the axis of starter drive unit 31. Drive element 81 presents a front section 97 having a smooth bore and a rear section 98 comprising grooves 84 cooperating with teeth 85 complementary to drive shaft 33. Front section 97 and rear section 98 are separated from one another by shoulder 92 forming the pressure element.

Drive pinion 32 is supported by a sleeve 100 of axial orientation having a boring 101 for its assembly on drive shaft 33. Sleeve 100 thus enables pinion 32 to be axially guided on a smooth section of drive shaft 33. A bearing bushing 102 shown on FIGS. 2 and 3 is preferably installed between the smooth section of drive shaft 33 and sleeve 100.

The rear end of this sleeve 100 is extended by reaction plate 91 of transverse orientation. This plate 91 is itself extended on its external periphery by an annular skirt 105 of axial orientation. This skirt 105 is directed towards the rear in the direction of drive element 81. Skirt 105 thus extends axially on the external periphery of reaction plate 91, directed in the direction opposed to pinion 32. The presence of sleeve 100 not being essential, pinion 32 could be solidly connected to reaction element 91 as shown in the figures of the document WO2006/100352. Reaction element 91, skirt 105, and possibly sleeve 100 are part of body 104 of pinion 32.

Plate 91 connected to pinion 32, annular skirt 105 linked to the external periphery of plate 91, as well as a locking ring 106 crossed centrally by drive element 81 thus delimit a housing 108 rotatably linked to pinion 32 inside which the friction discs 93, 94 are positioned. Shoulder 92 is installed inside housing 108.

First discs 93, known as internal discs, on their internal periphery comprise a plurality of sprockets inserted inside corresponding notches 109 situated in the external periphery of drive element 81. These notches 109 for example are grooves, the depth of which radially extends in an external wall of the drive element and the length of which extends along the X axis. Second discs 94, known as external discs, on their external periphery, comprise a plurality of sprockets inserted inside corresponding notches 110 situated in the internal periphery of annular skirt 105. These notches 110 for example are grooves, the depth of which radially extends in annular skirt 105 and the length of which extends along the X axis. Internal discs 93 are thus rotatably linked to drive element 81 and external discs 94 are rotatably linked to annular skirt 105. Discs 93, 94 may slide along the X axis by the means of notches 109, 110 and their corresponding sprockets.

Discs 93, 94 for example are produced in a friction material, such as bronze and steel, making it possible to transmit a torque by friction between drive element 81 and pinion 32. In the present case, there are two internal discs 93 and three external discs 94. However, this number of discs 93, 94 may vary depending on the application considered and the torque to be transmitted. It will therefore be possible to increase the number of discs 93, 94 in order to transmit more torque without having to increase the diameter of drive element 81.

In addition, locking ring 106 is hollowed out to its external periphery in an annular way to mount an assembly cap 112 of ring 106 and skirt 105 onto reaction plate 91. This cap 112 here is made of metal sheet and comprises a centrally perforated base. This base (not referenced) is in contact with the front face of plate 91 and is extended on its external periphery, via a chamfer, by an annular skirt of axial orientation in contact with the external periphery of skirt 105. The cap of annular shape therefore envelops skirt 105. In an alternative, ring 106 could be fixed to skirt 105 by clipping or welding or any other means of fixing such as screws for example.

Starter drive unit 31 also comprises a resilient means 115 exerting a force separating drive element 81 from reaction element 91 in the direction of the uncoupled position. To this effect, resilient means 115 when assembled is compressed between a radial surface of reaction element 91 and an end of drive element 81.

More precisely, resilient means 115 is positioned inside a channel 117 closed by a washer 118, known as retaining washer, rotatably linked to reaction element 91. As evident on FIG. 6, channel 117 is formed by a circular channel around the X axis of axial depth P, facing the radial surface of the front end of drive element 81. Channel 117 therefore corresponds to a reduction in thickness on the internal periphery of reaction plate 91.

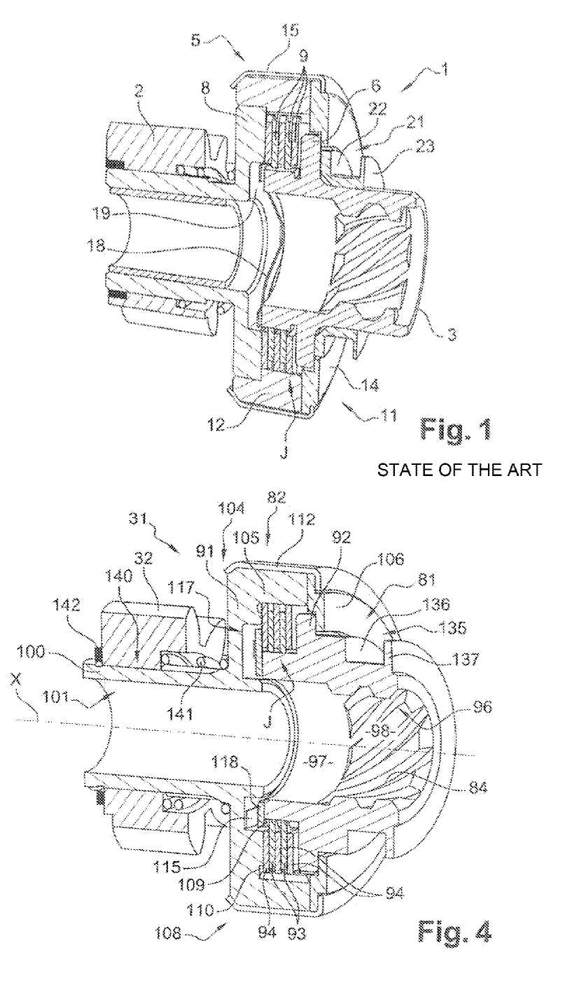

Channel 117 is axially open on the rear side and radially closed by two annular walls 120, 121 of axial orientation, an internal annular wall 120 which is nearest to the X axis and an external annular wall 121 which is furthest away from the X axis. These two walls 120, 121 delimit the internal L1 and external L2 diameter of channel 117 respectively. Base 119 of channel 117 is of radial orientation. The internal annular wall 120 corresponds to the axial extension of sleeve 100 towards the rear beyond reaction element 91. Internal annular wall 120 allows for easier centring of the washers inside channel 117. In an alternative, channel 117 has no internal wall 120, as shown on FIG. 1. The depth P of channel 117 is about 4 mm while internal L1 and external L2 diameters of channel 117 are about 11 mm and 26 mm respectively. The depth of channel 117 is dependent on the dimension of the return part forming the return means. The tube formed by wall 120 having an internal diameter of length L1 enables the seal of the clutch zone to be improved. Thus this permits a reduction in the risk of a foreign body such as dust ingress into the clutch zone.

Also, channel 117 on its external periphery comprises a set of three notches 124 angularly spaced in a regular way intended to receive three lugs 130 of corresponding shape, situated on the external periphery of retaining washer 118. These notches 124 have a depth substantially equal to that of the central part of channel 117. These notches 124 are each delimited by two parallel side rims 126 connected to each other by an end rim 127 substantially perpendicular to the two side rims 126, so that each notch 124 presents a substantially rectangular shape.

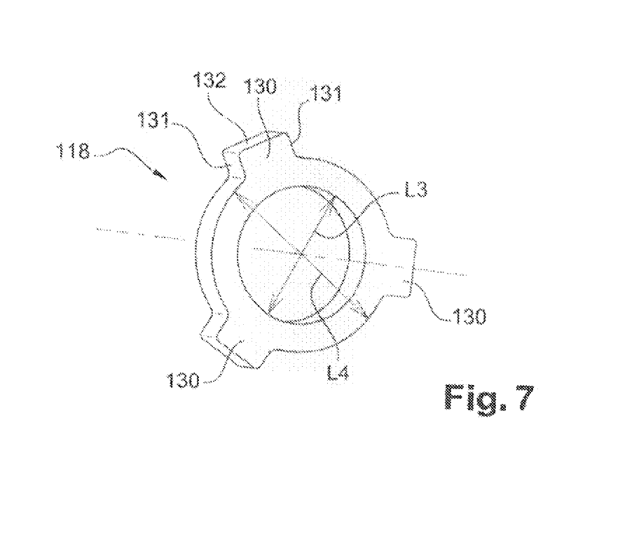

Retaining washer 118 shown in detail on FIG. 7 closes the open axial end of channel 117 inside of which resilient means 115 is positioned. This washer 118 presents the shape of an annular plate of radial orientation having an internal diameter L3 greater than internal diameter L1 of channel 117 and an external diameter L4 substantially less than external diameter L2 of channel 117, in the present case 25 mm. Also, retaining washer 118 on its external periphery comprises a set of three lugs 130 angularly spaced in a regular way intended to cooperate with three notches 124 of corresponding shape situated on the external periphery of channel 117. Thus these lugs 130 situated in the plane of retaining washer 118 are each delimited by two parallel side rims 131 connected to each other by an end rim 132 substantially perpendicular to the two side rims 131, so that each lug 130 presents a substantially rectangular shape.

Thus retaining washer 118 is rotatably linked to reaction plate 91 and can move in translation in relation to this plate 91 insofar as lugs 130 of retaining washer 118 can slide inside corresponding notches 124 machined in reaction plate 91. Of course, the number of lugs 130 and notches 124 depends on the application and could be greater or lesser than three. In all cases, this number is at least equal to one.

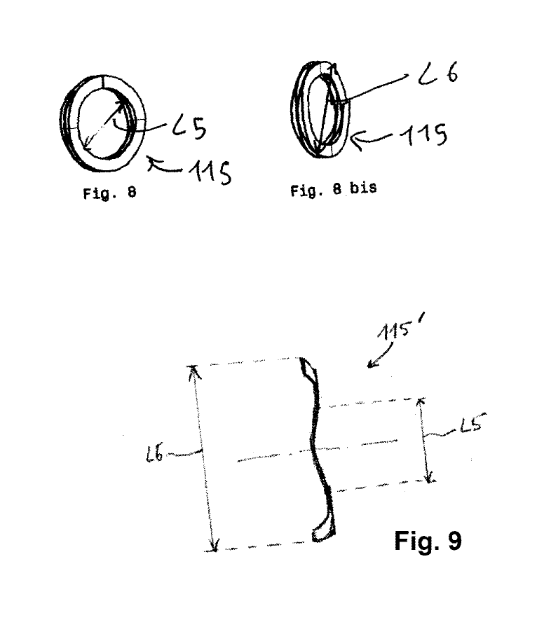

Resilient means 115 in the present case is a spring washer positioned inside channel 117. As shown on FIG. 9, this washer 115 of annular shape presents a corrugated profile and is made of metal for example. Preferably the resilient means is a multi-coil spring washer such as on FIGS. 8 and 8a. This multi-coil spring washer is a helical spring, the coils of which are corrugated just as the spring described above. This spring washer 115 has an internal diameter L5 substantially equal to internal diameter L1 of channel 117 and an external diameter L6 substantially equal to external diameter L2 of channel 117. In an alternative, resilient means 115 takes the form of a latch spring or a helical spring.

Spring washer 115 when assembled is compressed between base 119 of channel 117 and retaining washer 118 supported on the end of drive element 81 to separate drive element 81 from reaction element 91. Spring washer 115 thus exerts two opposing axial forces, one on drive element 81 towards the rear by the intermediary of retaining washer 118 and the other on reaction element 91 towards the front.

When reaction element 91 turns in relation to drive element 81, spring washer 115 wedged between base 119 of channel 117 and retaining washer 118 rotatably linked to reaction element 91 does not have any relative movement in relation to the components surrounding it so that spring washer 115 does not frictionally rub against these components. On the other hand, retaining washer 118 rubs against the end of drive element 81, opposite which retaining washer 118 is positioned. Spring washer 115 is thus protected from wear by retaining washer 118 which closes channel 117, inside of which spring washer 115 is positioned for its protection. The walls of channel 117 and retaining washer 118 thus form a protective housing for spring washer 115.

In order to decrease the wear of retaining washer 118, the latter advantageously can be protected with a coating. This coating could be obtained for example by carbonitriding.

Drive element 81 also has a channel 135 delimited by two walls 136, 137 of transverse orientation, inside of which the lower part of control lever 65 is intended to be assembled. The cross-section of channel 135 is substantially U-shaped. Wall 136 known as pusher is the wall against which lever 65 rests to push drive element 81 in the direction of ring gear 35. The other wall 137 known as puller is the wall against which lever 65 is supported to move drive element 81 away from ring gear 35. Alternatively, channel 135 could be formed on the basis of an annular part, with substantially U-shaped cross-section, mounted on the external periphery of drive element 81.

The operation of friction starter drive unit 31 according to the invention when starter 30 passes from the rest position to the active position and conversely is described below.

In rest position, drive element 81 being in the uncoupled position, discs 93, 94 are not tight so that there is an axial play J spread between pressure element 92, internal 93 and external 94 discs and reaction plate 91.

Starting from the rest position and contactor 64 being supplied with electricity, lever 65 initially acts on ring 106 of housing 108 which then moves sleeve 100 and pinion 32 axially in the direction of ring gear 35 along shaft 33. During this stage, drive element 81 is in the uncoupled position so that pinion 32 is free to rotate in both directions of rotation. The axial movement continuing, pinion 32 arrives in the vicinity of ring gear 35.

In a second phase, pinion 32 free in rotation slightly penetrates ring gear 35. During this second phase, control lever 65 comes into contact with pusher 136 so as to axially move drive element 81 and shoulder 92. Electric motor 37 being supplied with electricity, the rotation of drive shaft 33 shifts drive element 81 towards the coupled position by the means of helical grooves 84. The front end of drive element 81 then axially moves retaining washer 118 towards reaction plate 91 so that spring washer 115 is compressed. In addition, the play J is cancelled. Clutch 82 is then engaged in order to transmit the torque of pinion 32 to ring gear 35.

It is noted that lever 65 is thus configured to push firstly reaction element 91 by means of ring 106 and secondly drive element 81 by means of pusher 136. To this effect, control lever 65 for example can comprise a projection such as a slope and a second part situated between the lower end of lever 65 and the projection positioned between pusher 136 and puller 137. See document FR1156805 for more details concerning such a control lever.

When ring gear 35 turns more quickly than shaft 33 supporting drive pinion 32, friction clutch 82 is released because drive element 81 performs an axial movement towards the rear due to the helical connection between drive element 81 and shaft 33. Drive element 81 screws off to pass from the coupled position to the uncoupled position. This action is amplified by spring washer 115 which is de-tensioned and pushes drive element 81 towards the rear via retaining washer 118 supported on the end of drive element 81 which slides inside channel 117. In addition, return spring 80 operates to bring mobile core 71 and control lever 65 back towards their rest position shown on FIG. 2. Lever 65 thus moves starter drive unit 31 towards the rear by pushing on puller 137.

In the event of contact between reaction plate 91 and the end of drive element 81 during the declutching phase, spring washer 115 is protected by retaining washer 118. In fact, retaining washer 118 rotatably linked to reaction element 91 is that which rubs against the end of drive element 81. Spring washer 115 wedged between retaining washer 118 and base 119 of channel 117 then does not have any relative rotary movement in relation to the components surrounding it and thus cannot be subjected to premature wear.

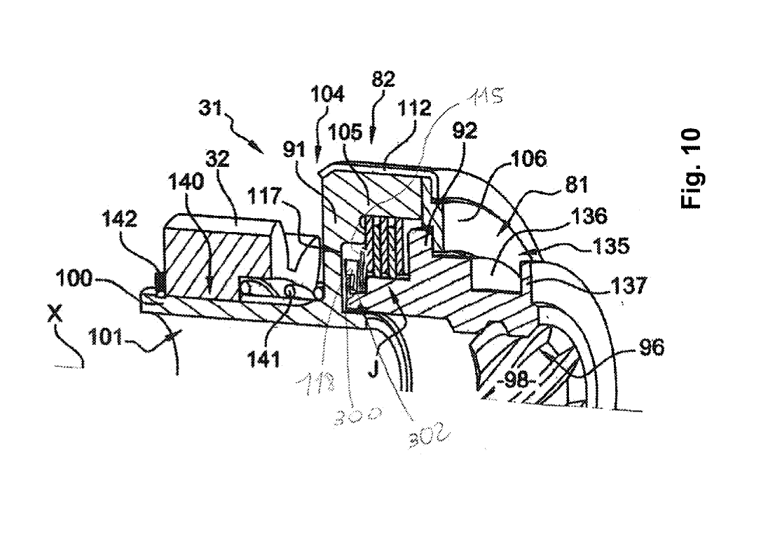

In an alternative, retaining washer 118 is rotatably linked to drive element 81, spring washer 115 then being positioned between a radial surface of drive element 81 and retaining washer 118. In the present case, spring washer 115 will also be protected from wear by retaining washer 118 which will come to rub against reaction plate 91 in the event of contact between reaction plate 91 and drive element 81. For example, in this mode of embodiment, the drive element comprises an internal or external channel 302. In the present case on FIG. 10 the channel is external. Retaining washer 118 is assembled so as to slide in relation to the drive element in the channel of the drive element and is solidly connected to the drive element by means of lugs for example. The retaining washer has a protrusion 300 which comes into contact with a surface of the reaction plate in coupled position. The plays are calculated so that in coupled position, resilient means 115 is never 100% compressed and so that there is a play in coupled position between the shoulder of channel 300 of the drive element facing the reaction plate and the surface of the reaction plate. Thus the retaining washer having a good surface friction characteristic comes into contact with the reaction plate. According to a mode of embodiment not shown, the reaction plate moreover can comprise a second retaining washer having a surface also having friction characteristics to tolerate rubbing against the surface of the protrusion of the retaining washer.

In alternative embodiment of friction clutch 82, the latter only comprises a pressure element 92 and a reaction element 91 presenting two truncated surfaces of complementary shape in contact with one another. A starting torque can be transmitted to the ring gear when a support force allowing these two surfaces to be rotatably linked is exerted by a movement of drive element 81. In this case, clutch 82 has no intermediate friction elements situated between pressure element 92 and reaction element 91. Reference should be made to document FR1056174 for more details on this embodiment of clutch 82.

In addition, according to an improvement enabling shocks and noises to be limited, it is proposed to mount pinion 32 with axial movement in relation to sleeve 100. To do this, an assembly 140 with complementary grooves operates between the external periphery of sleeve 100 and the internal periphery of pinion 32 distinct from sleeve 100. The grooves here are of axial orientation in contrast to the complementary helical grooves. This assembly creates a rotary connection between pinion 32 and sleeve 100.

In addition, a cylindrical wall of axial orientation situated at the rear of pinion 32 with the external periphery of sleeve 100 delimits a cavity for housing a flexible part 141, here a helical spring. This spring 141 is supported at one of its axial ends on the base of this cavity consisting of an annular wall of radial orientation connected to the internal periphery of pinion 32. The other axial end of the spring is supported on the front face of reaction element 91. Also, a circlip 142 is assembled in a channel machined in the front end of sleeve 100.

In the rest position of starter drive unit 31, spring 141 urges pinion 32 in the direction of circlip 142 constituting an axial thrust bearing. When the pinion 32 abuts against ring gear 35 and does not penetrate the latter, spring 141 is compressed and pinion 32 returns in the direction of reaction element 91 so that shocks and noises are minimized. In an alternative, pinion 32 is produced as one piece with sleeve 100.

1. Friction starter drive unit (31) for motor vehicle heat engine comprising:
a drive pinion (32) for meshing with a starter ring gear (35) of a heat engine,
a drive element (81),
a friction clutch (82) operating between the drive element (81) and the drive pinion (32), said friction clutch (82) comprising a reaction element (91) rotatably fixed to the drive pinion (32), and a pressure element (92) solidly connected to the drive element,
the drive element (81) being able to move in translation in relation to the reaction element (91) between an uncoupled position in which the drive element (81) and the drive pinion (32) are decoupled in rotation and a coupled position in which the drive pinion (32) and the drive element (81) are coupled to one another, and
a resilient means (115) exerting a force on the reaction element (91) and the drive element (81) in the direction of the uncoupled position, in which it also comprises a washer (118), known as retaining washer, rotatably fixed either to the reaction plate (91) or to the drive element (81), and
in the case where the retaining washer (118) is rotatably linked to the reaction plate (91), the resilient means (115) is positioned between said reaction plate (91) and the retaining washer (118), and
in the case where the retaining washer (118) is rotatably linked to the driver element (81), the resilient means (115) is positioned between said driver element reaction (81) and the retaining washer (118).

2. Friction starter drive unit according to claim 1, wherein the friction clutch (82) comprises at least one friction element (93, 94) situated between the pressure element (92) and the reaction element (91).

3. Friction starter drive unit according to claim 1, wherein the retaining washer (118) being rotatably connected to the reaction element (91), the resilient means (115) is positioned between a radial surface of the reaction element (91) and the retaining washer (118).

4. Friction starter drive unit according to claim 3, wherein the resilient means (115) and the retaining washer (118) are positioned inside a channel (117) formed in the reaction element (91).

5. Friction starter drive unit according to claim 4, wherein the retaining washer (118) on its external periphery comprises at least one lug (130) intended to cooperate with at least one notch (124) of corresponding shape situated on the external periphery of the channel (117).

6. Friction starter drive unit according to claim 5, wherein the retaining washer (118) on its external periphery comprises three lugs (130) spaced angularly apart from one another in a regular way intended to cooperate with three notches (124) of corresponding shape situated on the external periphery of the channel (117).

7. Friction starter drive unit according to claim 5, characterized in that the lugs (130) as well as the corresponding notches (124) present a substantially rectangular shape.

8. Friction starter drive unit according to claim 4, wherein the channel (117) is formed by a circular channel facing a radial surface of an end of the drive element (81).

9. Friction starter drive unit according to claim 8, wherein the channel (117) is radially delimited by an internal annular wall (120) and an external annular wall (121) of axial orientation in relation to an axis (X) of the friction starter drive unit (31).

10. Friction starter drive unit according to claim 9, wherein the internal annular wall (120) consists of an extension of a sleeve (100) supporting the drive pinion (32).

11. Friction starter drive unit according to claim 1, wherein the resilient means (115) consists of a spring washer.

12. Friction starter drive unit according to claim 1, wherein the retaining washer (118) is protected with a coating obtained by carbonitriding.

13. Friction starter drive unit according to claim 1, characterized in that the reaction element (91) is a plate rotatably fixed to the drive pinion (32).

14. Friction starter drive unit according to claim 2, characterized in that the reaction element (91) connected to the drive pinion (32), an annular skirt (105) of axial orientation in relation to the external periphery of the reaction element (91), and a locking ring (106) crossed centrally by the drive element (81) delimits a housing (108) inside of which the friction element (93, 94) is positioned.

15. Starter (30) for motor vehicle heat engine equipped with a friction starter drive unit (31) according to claim 1.

16. Friction starter drive unit according to claim 2, wherein the retaining washer (118) is rotatably connected to the reaction element (91), the resilient means (115) is positioned between a radial surface of the reaction element (91) and the retaining washer (118).

17. Friction starter drive unit according to claim 6, characterized in that the lugs (130) as well as the corresponding notches (124) present a substantially rectangular shape.

18. Friction starter drive unit according to claim 5, wherein the channel (117) is formed by a circular channel facing a radial surface of an end of the drive element (81).

19. Friction starter drive unit according to claim 6, wherein the channel (117) is formed by a circular channel facing a radial surface of an end of the drive element (81).

20. Friction starter drive unit according to claim 7, wherein the channel (117) is formed by a circular channel facing a radial surface of an end of the drive element (81).
